(19) United States
(12) Patent Application Publication
(10) Pub. No.: US 2026/0017561 A1
(43) Pub. Date: Jan. 15, 2026

(54) LOW-POWERED QUANTIZATION FOR MACHINE LEARNING MODELS

(71) Applicant: QUALCOMM Incorporated, San Diego, CA (US)

(72) Inventors: Nilesh Prasad PANDEY, La Jolla, CA (US); Jun MA, San Diego, CA (US); Markus NAGEL, Amsterdam (NL); Kevin Lishing HSIEH, San Diego, CA (US); An CHEN, San Diego, CA (US); Chirag Sureshbhai PATEL, San Diego, CA (US); Abhijit KHOBARE, San Diego, CA (US); Liang ZHANG, San Diego, CA (US); Eric Wayne MAHURIN, Austin, TX (US); Muralidhar Reddy AKULA, San Diego, CA (US); Joseph Binamira SORIAGA, San Diego, CA (US)

(21) Appl. No.: 18/889,753

(22) Filed: Sep. 19, 2024

Related U.S. Application Data
(60) Provisional application No. 63/669,331, filed on Jul. 10, 2024.

(51) Int. Cl. G06N 20/00

(52) U.S. Cl. CPC G06N 20/00

(57) ABSTRACT

Certain aspects of the present disclosure provide techniques and apparatus for machine learning. In an example method, a first plurality of quantization scales for a set of machine learning model parameters is accessed, and a shared quantization scale for the set of machine learning model parameters is accessed. A second plurality of quantization scales is generated based on the shared quantization scale and the first plurality of quantization scales. A dequantized set of machine learning model parameters is generated based on the shared quantization scale and the second plurality of quantization scales. A machine learning model output is generated based on the dequantized set of machine learning model parameters.

### CROSS-REFERENCE TO RELATED APPLICATION(S)

The present application for patent claims the benefit of priority to U.S. Provisional Appl. No. 63/669,331, filed Jul. 10, 2024, which is hereby incorporated by reference herein in its entirety.

### INTRODUCTION

Aspects of the present disclosure relate to machine learning.

A wide variety of machine learning model architectures have been trained to perform an assortment of diverse tasks, including computer vision tasks, language tasks, classification and regression tasks, and the like. Recently, research has yielded substantial success in using large models (e.g., deep neural networks, large language models (LLMs), large vison models (LVMs), large multimodal models (LMMs), and the like) to process and generate output data. Such large models are computationally expensive during inference (e.g., relying on substantial memory and power), rendering use of many modern machine learning models intractable on resource-constrained devices (such as battery-operated devices, smartphones, and the like).

Quantization techniques can enable efficient machine learning training/inference, such as on resource-constrained devices. Model quantization generally involves quantizing the parameters of a model (e.g., weights and/or biases) from a relatively high precision (e.g., floating-point values) that uses a relatively large number of bits per parameter (e.g., sixteen or thirty-two bits) to a relatively lower precision (e.g., integer values) stored using relatively fewer bits per parameter (e.g., four bits). Quantization can reduce memory bandwidth, reduce memory footprint, and increase compute efficiency (e.g., reducing power consumption and decreasing latency of inference).

### BRIEF SUMMARY

Certain aspects of the present disclosure provide a processor-implemented method, comprising: accessing a first plurality of quantization scales for a set of machine learning model parameters; accessing a shared quantization scale for the set of machine learning model parameters; generating a second plurality of quantization scales based on the shared quantization scale and the first plurality of quantization scales; generating a dequantized set of machine learning model parameters based on the shared quantization scale and the second plurality of quantization scales; and generating a machine learning model output based on the dequantized set of machine learning model parameters.

Certain aspects of the present disclosure provide a processor-implemented method, comprising: accessing a first plurality of quantization scales for a set of machine learning model parameters; determining a maximum quantization scale of the first plurality of quantization scales; generating a shared quantization scale for the set of machine learning model parameters based on the maximum quantization scale; and generating a second plurality of quantization scales based on the shared quantization scale and the first plurality of quantization scales.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example system for low power quantization, according to some aspects of the present disclosure.

FIG. 2 depicts example workflow for efficient blockwise quantization, according to some aspects of the present disclosure.

FIG. 3 depicts an example workflow for efficient blockwise computation in machine learning models, according to some aspects of the present disclosure.

FIG. 4 is a flow diagram depicting an example method for efficient multi-scale quantization, according to some aspects of the present disclosure.

FIG. 5 is a flow diagram depicting an example method for machine learning using multi-scale quantization, according to some aspects of the present disclosure.

FIG. 6 is a flow diagram depicting an example method for generating multi-scale quantization, according to some aspects of the present disclosure.

FIG. 7 is a flow diagram depicting an example method for inferencing using multi-scale quantization, according to some aspects of the present disclosure.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning. Specifically, in some aspects of the present disclosure, techniques for low-power quantization machine learning are provided.

In the context of machine learning, quantization can be performed using a variety of techniques and may be categorized at least in part by the granularity of the quantization scheme. For example, quantization granularities may include per-tensor quantization (also referred to in some aspect as “tensorwise” quantization), where a single set of quantization parameters, such as a scale and a zero point, are generated for all elements in the tensor. Another scheme includes per-channel quantization (also referred to in some aspects as “channelwise” quantization), where each channel in the tensor may have a corresponding unique set of quantization parameters. As another example, per-block quantization (also referred to as “blockwise,” “per-group,” or “groupwise” quantization in some aspects) may be used. For blockwise computation, each block of the tensor (e.g., each sub-channel), such as a proper subset of elements in a given channel, may have a corresponding set of quantization parameters. For example, a given channel may include N blocks of elements, where each of the N blocks can be encoded using a different set of quantization parameters.

Different quantization granularities may have different impacts on model performance (e.g., where finer quantization granularity results in lower quantization-induced error in the model output). However, different quantization granularities may also rely on dedicated hardware components (e.g., compute kernels) for efficient implementation. Accordingly, implementing a particular quantization granularity on a device or system that does not have dedicated kernel(s) for the particular granularity may result in substantial increased inferencing latency. While tensorwise quantization and channelwise quantization are often supported by a variety of systems, few (if any) support efficient blockwise quantization.

In some aspects of the present disclosure, techniques for efficient implementation of blockwise quantization without dedicated hardware are provided. These techniques may be referred to as low-powered block quantization (LPBQ). In some aspects, the efficient blockwise quantization computation can be implemented using software (rather than relying on dedicated hardware kernels) in conjunction with existing compute units that support channelwise compute. This allows more granular blockwise computation to be performed using existing channelwise hardware, substantially improving the capacity of such devices. Further, in some aspects, the described techniques can more generally be used to reduce the memory footprint of quantized machine learning models substantially while preserving model accuracy, regardless of whether the quantization granularity is changed.

In some aspects of the present disclosure, each channel of parameters (e.g., weights) for a machine learning model may be divided into multiple logical blocks, where each block is quantized individually (e.g., with a corresponding set of quantization parameters). That is, the parameters of a trained machine learning model may be blockwise quantized, such that each block of each tensor is quantized separately. In some aspects, these per-block quantized weights (or other parameters) can be mapped onto a relatively higher bitwidth per-channel quantization grid, enabling efficient utilization of existing kernels. In some aspects, using this quantization conversion approach can result in an improved tradeoff between model footprint and accuracy, as compared to conventional quantization approaches. For example, in some aspects, a model having a similar sized footprint and a higher prediction accuracy can be generated, as compared to approaches using per-tensor and/or per-channel schemes. As another example, a model having similar prediction accuracy using a smaller memory footprint can be generated, as compared to approaches using per-tensor and/or per-channel schemes.

As discussed above, blockwise computation relies on per-block granularity, which relies on either custom hardware kernel(s) or on extensive use of floating-point representations for computation. However, custom kernels are difficult and time-consuming to develop for machine learning accelerators, and floating-point computation is highly power-consuming and compute-inefficient. Aspects of the present disclosure can be used to implement efficient blockwise quantization without dedicated hardware or substantial computational overhead.

### Example System for Low Power Quantization

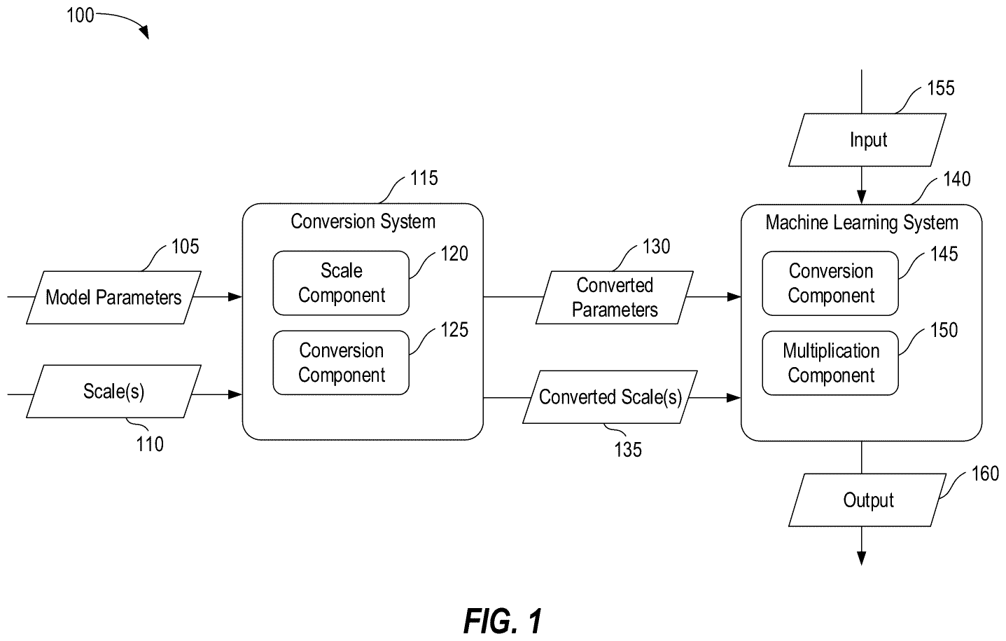

FIG. 1 depicts an example system 100 for low power quantization, according to some aspects of the present disclosure.

In the illustrated example, model parameters 105 and a set of quantization scale(s) 110 are accessed by a conversion system 115. As used herein, accessing data may generally include receiving, requesting, retrieving, obtaining, collecting, generating, or otherwise gaining access to the data. In some aspects, the model parameters 105 may correspond to a machine learning model (e.g., weights or other parameters of a generative artificial intelligence (genAI) model, such as an LLM or an LVM or the like). In some aspects, the model parameters 105 are quantized (e.g., by a quantization system, which may be the conversion system 115, or may be a separate quantization system). In some aspects, the model parameters 105 are quantized using blockwise granularity (e.g., unique quantization parameters for each block of each channel in the model parameters 105).

In some aspects, the model parameters 105 may correspond to the original (e.g., full-precision) non-quantized parameters of the model. That is, the model parameters 105 may be processed at or by the conversion system 115 to generate blockwise quantization encodings for the parameters, but the model parameters 105 themselves may be full precision (e.g., thirty-two-bit or sixteen-bit floating point).

In some aspects, the scales 110 comprise quantization scales for each block in the model parameters 105. That is, each block of parameters in the model parameters 105 may have a corresponding quantization scale from the scales 110. As discussed above, these block-specific scales (e.g., blockwise scales 110) enable blockwise quantization. In some aspects, as discussed above, each “block” of the model parameters 105 may generally correspond to a subset of elements (e.g., weights) from a given channel in a given parameter tensor (e.g., a weight tensor). For example, a given weight tensor may include N channels, where each channel comprises M weights logically subdivided into B blocks. Generally, the particular block definition (e.g., the number and size of blocks for each channel) may vary depending on the particular implementation. Further, although the illustrated example depicts blockwise quantization scales 110, in some aspects, the blockwise quantization encodings for the model parameters 105 may generally include any other relevant encoding information.

As illustrated, the conversion system 115 processes the model parameters 105 and the scales 110 to generate a set of converted parameters 130 and a set of converted scales 135. In the illustrated example, the conversion system 115 is generally representative of any computing system capable of performing the operations described herein. Although depicted as a discrete system for conceptual clarity, in some aspects, the conversion system 115 may be implemented across any number of components and systems, and may be implemented using hardware, software, or a combination of hardware and software.

In the illustrated example, the conversion system 115 includes a scale component 120 and a conversion component 125. Although depicted as discrete components for conceptual clarity, the operations of the depicted components (and others not illustrated) may be combined or distributed across any number of components and systems, and may be implemented using hardware, software, or a combination of hardware and software.

In some aspects, the scale component 120 evaluates the scales 110 to generate the converted scales 135. For example, in some aspects, the scale component 120 may be used to implement a two-scale (or, more generally, a multi-scale) quantization encoding scheme for the model parameters 105, where the quantization encodings (e.g., scales) for each block of the model parameters 105 are defined based on two (or more) independent scales. For example, in some aspects, the scale component 120 may, for each given channel in a given tensor of the model parameters 105, generate a shared scale that applies to all elements in the given channel, as well as a set of blockwise scales that each apply to a corresponding block of elements in the given channel. As another example, for each tensor in the model parameters 105, the scale component 120 may generate a shared tensorwise scale for all elements in the tensor, a set of channelwise scales (one for each channel in the tensor), and/or a set of blockwise scales (one for each block in the tensor).

In some aspects, to generate the multi-scale encodings, the scale component 120 may determine the maximum scale of the set of scales 110. The scale component 120 may generate a shared quantization scale for a set of multiple blocks of parameters based on this maximum scale. That is, if the scales 110 are blockwise scales corresponding to a single channel of a single tensor, the scale component 120 may generate a channelwise scale shared among the blocks of the channel based on the maximum blockwise scale 110. As another example, if the scales 110 are blockwise scales of an entire tensor, the scale component 120 may generate a tensorwise scale based on the maximum blockwise scale in the tensor, and/or a set of channelwise scales based on the largest blockwise scale within each channel.

In some aspects, a set of new scales (e.g., one for each block in the model parameters 105) may then be generated based at least in part on the new shared scale(s) (e.g., the channelwise scale and/or the tensorwise scale). For example, in some aspects, new (converted) blockwise scales may be generated by factoring out the new channelwise scale from each blockwise scale (e.g., dividing each blockwise scale by the shared channelwise scale to generate new blockwise scales). In some aspects, the new scales for each block may be encoded using a relatively small bitwidth (e.g., as an integer with four bits), as compared to the scales 110 (which may be encoded using a higher precision bitwidth, such as using floating-point values in sixteen bits). That is, using a shared channelwise (and/or tensorwise) scale can allow the individual blockwise scales to be represented using lower precision (e.g., lower bitwidth) without sacrificing quantization accuracy (e.g., without increasing, or without substantially increasing, quantization error).

In some aspects, the input quantization parameters (e.g., the scales 110) may be defined as s=(s₁, . . . , sₙ) for n blocks in a channel of the model parameters 105. That is, each block in the model parameters 105 may have a corresponding scale (e.g., where the k-th block has a blockwise quantization scale sₖ). The scale component 120 may generate sₘₐₓ=max(s). That is, sₘₐₓ may be defined as the largest block-specific scale of a set of blocks (e.g., the blocks of a single channel, if a shared channelwise scale is being generated, or the blocks of a tensor, if a shared tensorwise scale is being generated), as found in the set of scales 110. Suppose further that the new block-specific scales (e.g., the converted scales 135) for the channel are defined as I=(I₁, . . . , Iₙ). In some aspects, as discussed above, each element of I is encoded using a lower bitwidth, as compared to the elements of s. For example, the domain of the block-specific converted scales 135 may be Iⱼ∈(Iₘᵢₙ, . . . , Iₘₐₓ)∀j. That is, the block-specific converted scales 135 may have values between Iₘᵢₙ (e.g., the smallest value that can be stored using the encoding selected for the converted scales) and Iₘₐₓ (e.g., the largest value that can be stored using the encoding selected for the converted scales). For example, in some aspects, if the conversion system 115 uses four-bit integer encoding for the converted blockwise scales, the domain of I may be [1,16]. In some aspects, the domain of I need not be integer or uniform, and may be fractional (e.g., with Iₘₐₓ=1.0).

In some aspects, the shared scale for a set of blocks (e.g., all blocks in a given channel) may then be defined using Equation 1 below, where γ is the shared scale for the set of blocks (e.g., a shared channel scale):

$$γ = \frac{{s}_{max}}{{I}_{max}} \qquad ( 1 )$$

In some aspects, if exponential scaling is used, the new per-block scales I (e.g., the integer component) may instead be sub-exponents, and the shared scale may be defined as γ=sₘₐₓ−Iₘₐₓ.

In some aspects, after defining the shared scale of the set of blocks, the scale component 120 may then generate values for the updated block-specific scales (e.g., Iₖ for each block k∈(1, . . . n)). For example, in some aspects, the new block-specific scales (e.g., blockwise scales 135) may be defined using Equation 2 below:

$${I}_{k} = clamp ( round ( \frac{{s}_{k}}{γ} ) , {I}_{min} , {I}_{max} ) ∀ k = 1 , … , n \qquad ( 2 )$$

That is, the scale component 120 may, for each respective block in the model parameters 105, generate an interim scale by dividing the corresponding blockwise scale (from the scales 110) by the newly generated shared scale γ that corresponds to the block. The scale component 120 may then round this interim scale to the nearest integer, and may then clamp the rounded interim scale to the range that can be encoded using the target bitwidth (e.g., setting rounded interim scales that are below the minimum value of the range to the minimum value, and setting rounded interim scales that are above the maximum value of the range to the maximum value). The result of this clamping is the new set of converted blockwise scales 135 for the blocks. In some aspects, as discussed above, if exponential scaling is used, the new block-specific scales (e.g., blockwise scales 135) may be similarly defined as Iₖ=clamp(round(sₖ−γ), Iₘᵢₙ, Iₘₐₓ)∀k=1, . . . , n.

In some aspects, as discussed above, a similar approach may be used to generate shared tensorwise scales. For example, rather than generating a shared channelwise scale for each channel, the scale component 120 may instead generate a single shared tensorwise scale for the tensor. Further, in some aspects, the scale component 120 may combine shared channelwise and tensorwise scales. In some aspects, after generating shared channelwise scales as discussed above, the scale component 120 may repeat the process to generate a shared tensorwise scale based on the new channelwise scales. For example, the scale component 120 may define the tensorwise scale as

$${γ}_{t} = \frac{{γ}_{c \_ max}}{{I}_{c \_ max}} ,$$

where γₜ is the shared tensorwise scale, γ_{c_max} is the maximum max value of the set of shared channelwise scales (generated as discussed above), and I_{c_max} is the largest value that can be encoded using the target bitwidth that will be used to encode the channelwise scales.

The scale component 120 may then define new values for each channelwise scale (e.g., γ_{c}) based on the new tensorwise scale, such as using Equation 2 above and replacing Iₖ (the new blockwise scale for the k-th block) with γ_{c_k} (the new channelwise shared scale for the k-th channel), sₖ with γ_{p_k} (the previous or interim channelwise shared scale for the k-th channel, such as generated using Equation 1 above), γ with γₜ (the new tensorwise shared scale for the tensor), and Iₘᵢₙ and Iₘₐₓ with γ_{c_min} and γ_{c_max}, respectively (the minimum and maximum values that can be encoded using the bitwidth of the new converted channelwise scales, as discussed above). This may allow the shared channelwise scales to be encoded using a relatively smaller bitwidth, further reducing memory footprint of the model.

In some aspects, during inferencing, the final scale for a given block may be defined as σₖ=γIₖ for the k-th block (e.g., for each block). In some aspects, for exponential scaling, the new scales may be defined as σₖ=γ+Iₖ. In some aspects, therefore, the converted scales 135 may be defined or represented as (γ, I₁, . . . , Iₙ). That is, the converted scales 135 for a given channel in the model parameters 105 may include a new shared scale γ, as well as block-specific scales I₁, . . . , Iₙ for the n blocks of parameters in the channel. In some aspects, the shared scale may be stored or encoded using a relatively high precision encoding (e.g., sixteen-bit floating point). In some aspects, the shared scale may be encoded with the same precision as the scales 110. However, the new block-specific scales I may each be encoded with fewer bits (e.g., as four-bit integers). This substantially reduces the memory footprint of the converted scales 135, as compared to the scales 110.

That is, each blockwise scale can be decomposed into two or more scales (e.g., one or more shared scales for the channel and/or tensor to which the block corresponds, as well as a new blockwise scale for the block). Advantageously, the converted blockwise scales (and, in some cases, the shared channelwise scales) can be stored using relatively fewer bits (e.g., a lower bitwidth encoding, such as four-bit integer), as compared to the scales 110 used in conventional systems (e.g., sixteen-bit floating point). In some aspects, the shared channelwise scale may be encoded using a higher bitwidth (e.g., sixteen-bit floating point) to preserve accuracy and reduce quantization error. However, because each blockwise scale can be stored in substantially fewer bits, the overall memory footprint of the converted scales 135 may be substantially less than the footprint of the scales 110. For example, suppose a given channel in the model parameters 105 is delineated into sixteen blocks of parameters, where each block has a corresponding blockwise scale (in the scales 110) represented using sixteen-bit floating point. The scales 110 for this channel may therefore consume two hundred fifty-six bits (sixteen bits for each of sixteen blocks). The converted scales 135 for the given channel, however, may comprise a single shared channelwise scale (γ) encoded using one bitwidth (e.g., sixteen-bit floating point) and a set of sixteen new blockwise scales (I=(I₁, . . . , I₁₆)) encoded in a smaller bitwidth (e.g., four bits), resulting in a total memory footprint of eighty bits for the converted scales 135 of the given channel (sixteen bits for the shared channel scale and four bits for each of the sixteen blocks).

In the illustrated environment, the model parameters 105 can then be requantized using the new converted scales 135 (or the original full-precision parameters for the model may be quantized using the converted scales 135) to generate the converted parameters 130. That is, the parameters of the machine learning model may be requantized using the converted scales 135 (e.g., using a blockwise scale of σₖ for the k-th block, as discussed above). Advantageously, this conversion process may be completed in an offline manner (e.g., after training the model, but before deploying the model for runtime use). In the illustrated example, the converted parameters 130 and the converted scales 135 are accessed by a machine learning system 140. Although depicted as a discrete system for conceptual clarity, in some aspects, the machine learning system 140 may be the same as the conversion system 115.

In the illustrated example, the machine learning system 140 includes a conversion component 145 and a multiplication component 150. The conversion component 145 may generally process the converted scales 135 to convert the converted scales 135 (which include per-block scales, as discussed above) to per-channel scales. For example, for each channel in each parameter tensor (reflected in the converted parameters 130), the conversion component 145 may multiply the corresponding shared channel scale γ with the corresponding block-specific scale Iₖ to generate the total scale σₖ of the k-th block. The conversion component 145 may then scale the parameters accordingly for each block in the converted parameters 130 (e.g., multiplying each element using the converted scale σₖ). This allows the conversion component 145 to generate dequantized parameters based on blockwise quantization without relying on a dedicated hardware kernel.

In some aspects, during this conversion process, the conversion component 145 may optionally upconvert the parameters (e.g., to eight bits, from four). For example, if each of the converted parameters 130 is encoded in four-bit integer, the conversion component 145 may generate eight-bit channelwise weights for each channel of the input tensors.

Generally, the dequantization process performed by the conversion component 145 may be performed using a variety of techniques, depending on the particular implementation. For example, in some aspects, the conversion component 145 may correspond to or use a matrix engine (e.g., matrix-multiplication accelerator hardware), such as a dedicated matrix-multiplication engine on a graphics processing unit (GPU), central processing unit (CPU), or other processing unit of the computing system, to multiply the converted parameters 130 by the set of overall scales σₖ of each of the k blocks. As another example, in some aspects, the conversion component 145 may correspond to or use sequential multiplications (e.g., on a CPU) to dequantize each block of parameters sequentially. As yet another example, in some aspects, the conversion component 145 may use one or more accelerator instructions to perform the dequantization, such as using hardware such as a neural signal processor (NSP) and/or a neural processing unit (NPU).

In the illustrated example, during runtime, the machine learning system 140 accesses input 155 for the machine learning model. The machine learning system 140 generates a model output 160 using the converted parameters 130 and converted scales 135. For example, as discussed above, the input 155 (or features generated therefrom) may be represented as a tensor of elements (e.g., activation data). This tensor may then be processed using the dequantized weights (e.g., using matrix multiplication of the weights and input 155) by the multiplication component 150 to generate a new tensor. This new tensor may then be used as input to a subsequent component of the model, or the new tensor may be used as the output 160 of the model.

In this way, the system 100 allows blockwise quantization to be implemented efficiently and without relying on dedicated hardware kernels to generate machine learning models with reduced model footprint and/or higher model accuracy, as compared to some conventional solutions.

### Example Workflow for Efficient Blockwise Quantization

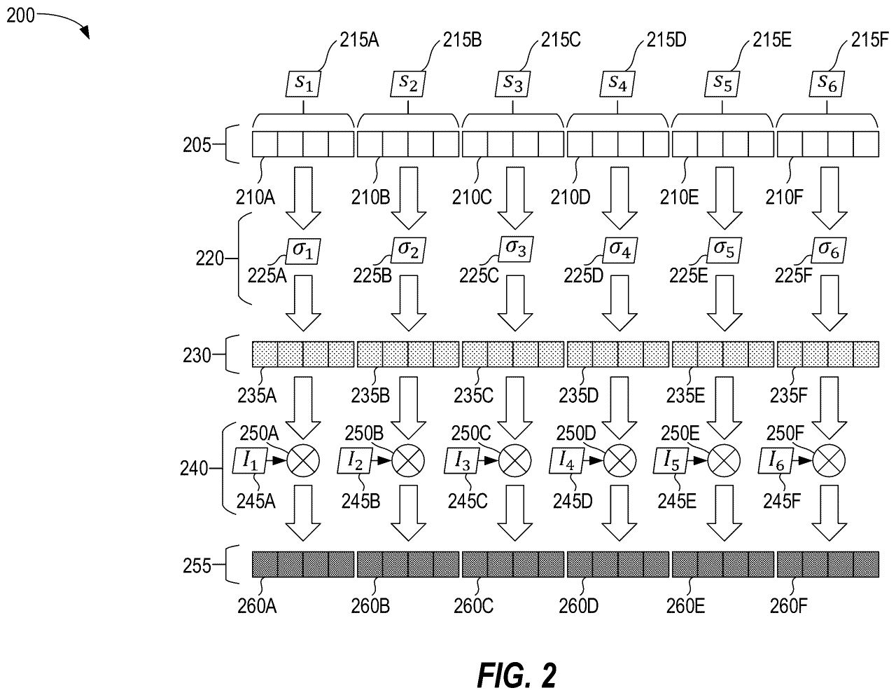

FIG. 2 depicts example workflow 200 for efficient blockwise quantization, according to some aspects of the present disclosure. In some aspects, the workflow 200 is performed by a conversion system and/or a machine learning system, such as the conversion system 115 and the machine learning system 140 of FIG. 1.

In the illustrated example, a set of model parameters 205 (designated as w^{FP} in some aspects, to refer to “full precision” and/or “floating point” weights) is accessed. In some aspects, the model parameters 205 are encoded in full precision (e.g., the original non-quantized weights for the model, such as encoded using floating-point format). In some aspects, the model parameters 205 correspond to a single channel of a single parameter tensor, as discussed above. In the illustrated workflow 200, the set of model parameters 205 comprises a set of blocks 210A-F (collectively, blocks 210). That is, the model parameters 205 may correspond to a single channel of a weight tensor, where the channel is logically divided into six blocks 210 (with four elements or weights in each block 210, in the illustrated example) for blockwise quantization. That is, as illustrated, each respective block 210 has a respective block-specific quantization scale (e.g., collectively referred to as blockwise scale 215, (designated as sₖ, k∈(1, . . . 6) in the illustrated example)). Specifically, the first block 210A has a corresponding blockwise quantization scale 215A (s₁), the second block 210B has a corresponding blockwise quantization scale 215B (s₂), and so on. In some aspects, as discussed above, each of the blockwise scales 215 may be encoded using a first (relatively high) precision (e.g., sixteen-bit floating point). In some aspects, the scales 215 may be determined by a quantization system for the model parameters 205, but the depicted parameters may themselves be unquantized for full precision.

As illustrated, each block 210 of the model parameters 205 can then be quantized using an updated set of scales 225A-F (collectively, scales 225) (e.g., the converted scales 135 of FIG. 1), as illustrated by a quantization operation 220. In the illustrated example, each block 210 has a corresponding converted scale 225. Specifically, the parameters of each block 210 at index k are quantized using a corresponding scale 225 σₖ, where σₖ=γIₖ, k∈(1, . . . K) (where K=6 in the illustrated example). As discussed above, γ may be a shared scale for the channel (shared across blocks 210), while Iₖ may be a block-specific scale for the k-th block 210. In the illustrated example and as discussed above, γ and the resulting scales 225 may be encoded or represented using a relatively high precision (e.g., sixteen-bit floating point). In some aspects, the precision of the shared scale and the scales 225 is the same as the precision of the original scales s. However, by using blockwise scales I with a smaller bitwidth (e.g., four bits), the system can significantly reduce model footprint.

As illustrated, these converted parameters 230 (denoted as w^{N} in some aspects) may correspond to the converted parameters 130 of FIG. 1. That is, the converted parameters 230 may correspond to the original full-precision model parameters 205 of the machine learning model, quantized according to the new quantization scales 225 (e.g., the shared channelwise scale and the unique blockwise scales). In some aspects, the converted parameters 230 may be stored in a relatively small bitwidth (e.g., four-bit integer). In some aspects, the converted parameters 230 use the same precision as the new block-specific scales I. In some aspects, as discussed above, this quantization and conversion process can be performed offline.

In the illustrated workflow, at runtime, the converted parameters 230 may be dequantized (using a dequantization operation 240) using the corresponding block-specific scales 245A-F (collectively, converted blockwise scales 245). That is, the converted blockwise scales 245 (designated I_{1, . . . 6} in the illustrated example) and the shared scale for the channel γ may be used to dequantize the converted parameters 230 using multiplication operations 250 in order to generate parameters 255. In some aspects, as discussed above, the parameters 255 are optionally upscaled or upconverted (e.g., from four bits to eight bits). For example, the illustrated workflow, the converted parameters 230 may be upconverted from N-bit integers to M-bit integers (where M>N), such as from four bits to eight bits, to form the parameters 255.

In some aspects, as discussed above, this process enables parameters to be encoded using multiple scales (e.g., a shared scale for multiple blocks, such as a channel, as well as block-specific scales for each block in the channel). This can substantially reduce model footprint and accelerate inferencing. Further, as discussed above, the disclosed techniques can enable computing systems to implement blockwise computation without relying on dedicated hardware support.

### Example Workflow for Efficient Blockwise Computation in Machine Learning Models

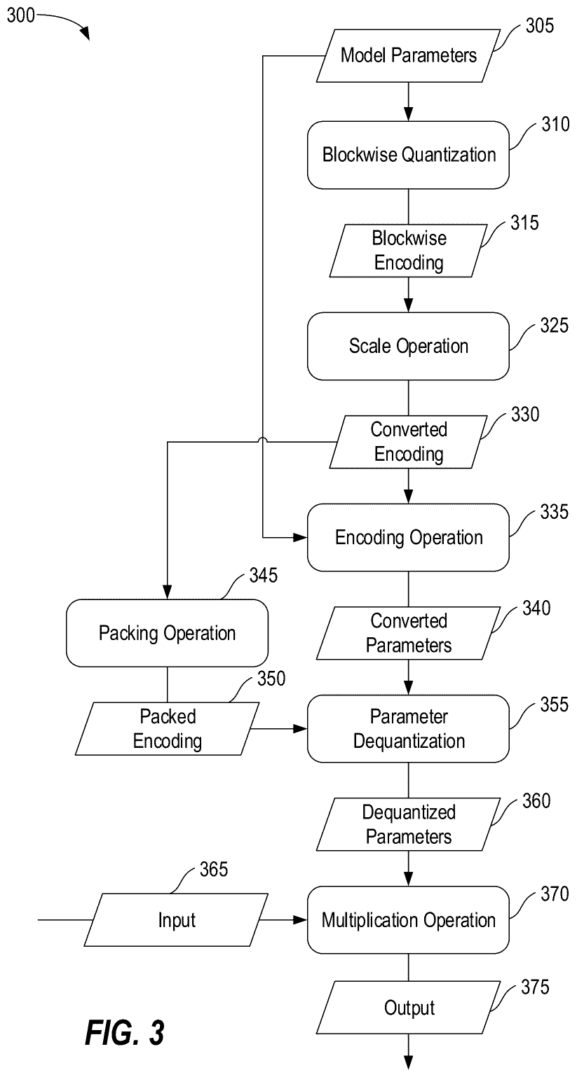

FIG. 3 depicts an example workflow 300 for efficient blockwise computation in machine learning models, according to some aspects of the present disclosure. In some aspects, the workflow 300 is performed by a conversion system and/or a machine learning system, such as the conversion system 115 and the machine learning system 140 of FIG. 1 and/or the conversion system and/or machine learning system discussed above with reference to FIG. 2.

In the illustrated workflow 300, a set of full-precision model parameters 305 (e.g., weights encoded in floating point) are processed using a blockwise quantization operation 310 (sometimes referred to as a blockwise encoding generation operation) to generate blockwise encodings 315. In some aspects, the blockwise quantization operation 310 generally corresponds to generation of blockwise encodings 315 for the input model weights (or other parameters), but the blockwise quantization operation 310 may or may not include actually quantizing the model parameters 305 using those blockwise encodings 315. For example, the blockwise quantization operation 310 may generate blockwise scales for four-bit quantization, where the input comprises the model parameters 305 in a first (high) precision (such as floating point) and the output is blockwise encodings 315 (e.g., quantization parameters, such as the scales s) for the model parameters 305 that would allow the model parameters 305 to be quantized to the target bitwidth (e.g., four bits).

As illustrated, these initial blockwise encodings 315 are then processed using a scale operation 325 (which may correspond to the scale component 120 of FIG. 1) to convert the blockwise encodings 315 (e.g., the scales s) from original blockwise parameters to more efficient encodings, as discussed above. In some aspects, the scale operation 325 may perform or implement LPBQ encoding generation operations, as discussed above. For example, the conversion may generate converted encodings 330 (e.g., updated quantization parameters, referred to as LPBQ parameters in some aspects) such as a shared scale (e.g., γ) for a set of blocks (e.g., all blocks in a channel), as well as updated block-specific scales (e.g., Iₖ) for each block. In some aspects, the converted encodings 330 correspond to the converted scales 135 of FIG. 1.

In the illustrated workflow 300, an encoding operation 335 (sometimes referred to as a weight encoding operation) can access the initial (full-precision) model parameters 305, as well as the converted encodings 330, to generate converted parameters 340 (e.g., quantized or encoded parameters). In some aspects, the converted parameters 340 correspond to the converted parameters 130 of FIG. 1 and/or the converted parameters 230 of FIG. 2. For example, in some aspects, the encoding operation 335 may quantize the model parameters 305 to four-bit integers using the converted encodings 330 (e.g., the updated quantization scales γ and I), as discussed above. For example, as discussed above, the scale σₖ for the k-th block may be defined as γIₖ.

As illustrated, a packing operation 345 may optionally be used to process the converted encodings 330 to generate packed encodings 350. In some aspects, the packing operation 345 may correspond to packing some or all of the converted encodings 330 (e.g., the updated blockwise scales, which may be represented using a relatively low precision, such as four-bit integer) into smaller blocks. For example, four blockwise scales may be packed into the space which would be used by a single (sixteen-bit) scale of the blockwise encodings 315. This can substantially reduce the model footprint.

In the illustrated example, the packed encodings 350 (or, in some aspects, the converted encodings 330 themselves) are processed by a parameter dequantization operation 355 (referred to in some aspects as a weight conversion operation), along with the converted parameters 340. The parameter dequantization operation 355 may process the converted parameters 340 using the packed encodings 350 (or the converted encodings 330) to dequantize the parameters, resulting in the dequantized parameters 360. In some aspects, as discussed above, the parameter dequantization operation 355 may optionally upscale the parameters (e.g., to eight-bit weights).

Further, in the workflow 300, the dequantized parameters 360 are processed by a multiplication operation 370 (e.g., matrix multiplication) in conjunction with an input tensor 365 (e.g., the input 155 of FIG. 1, such as an activation tensor encoded in sixteen-bit integers) to generate an output 375 of the layer or portion of the model.

In some aspects, this workflow 300 may be performed for each channel of the tensors and/or each layer of the model. In some aspects, some of the depicted operations (e.g., the blockwise quantization operation 310, the scale operation 325, the encoding operation 355, and/or the packing operation 345) may be performed offline or prior to inferencing, while others (e.g., the parameter dequantization operation 355 and/or the multiplication operation 370) may be performed online during runtime.

Although not depicted in the illustrated example, in some aspects, the workflow 300 may be adapted to perform mixed-precision LPBQ. For example, the computing system may determine to convert a subset of the blockwise encodings 315 to low bitwidths (e.g., using shared channel scales and small blockwise scales) while retaining some other scales in full precision or in higher bitwidth encodings. Such mixed precision may enable more fine-tuned quantization, potentially resulting in improved model accuracy with reduced quantization loss while still reducing model size.

### Example Method for Efficient Multi-Scale Quantization

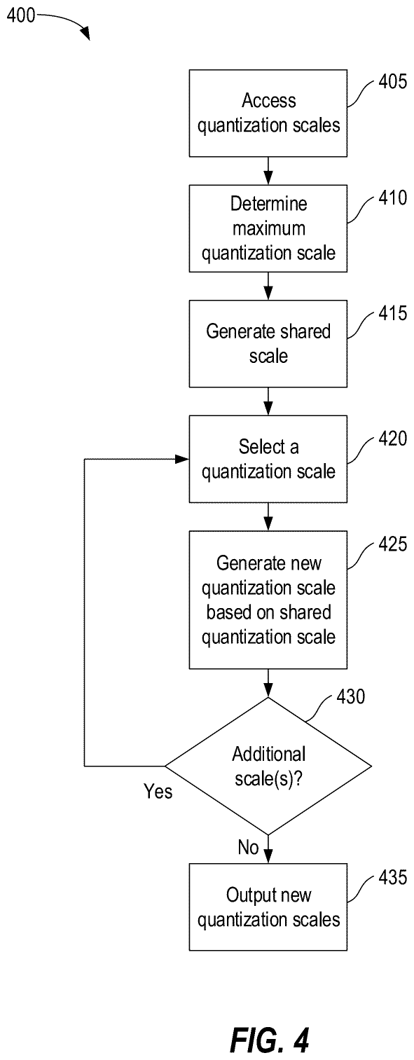

FIG. 4 is a flow diagram depicting an example method 400 for efficient multi-scale quantization, according to some aspects of the present disclosure. In some aspects, the method 400 is performed by a conversion system and/or a machine learning system, such as the conversion system 115 and the machine learning system 140 of FIG. 1 and/or the conversion system and/or machine learning system discussed above with reference to FIGS. 2-3. Generally, the method 400 may be performed by any computing system.

At block 405, the computing system accesses a set of quantization scales (e.g., the scales 110 of FIG. 1, the blockwise quantization scales 215 of FIG. 2, and/or the blockwise encodings 315 of FIG. 3). In some aspects, as discussed above, the quantization scales correspond to blockwise quantization encodings for parameters of a machine learning model. For example, the quantization scales may include block-specific scales for a set of blocks (e.g., the blocks that make up a single channel in the parameters).

At block 410, the computing system determines the maximum scale of the set of quantization scales (e.g., the block-specific scale having a highest value of the set of block-specific scales for the channel). In some aspects, as discussed above, this maximum blockwise scale of the set of scales may be referred to as sₘₐₓ).

At block 415, the computing system generates a shared scale (e.g., γ) for the set of blocks in the channel. In some aspects, as discussed above, the shared scale may be one of the scales in the set of converted scales 135 of FIG. 1. For example, as discussed above, the computing system may determine the maximum value that can be encoded using the target bitwidth that will be used to store the converted blockwise encodings (e.g., Iₘₐₓ) to compute the shared scale based on the maximum value of the (current) blockwise scales and the maximum possible value of the converted blockwise scales using Equation 1 above.

At block 420, the computing system selects one of the original blockwise scales (e.g., an sₖ for block k) from the set of original quantization scales (accessed at block 405) in order to convert the selected blockwise scale to an updated scale. Stated differently, the computing system may select one of the blocks of the channel to generate a new blockwise scale for the block. Generally, the computing system may use any technique to select the scale and/or block, as all scales and/or blocks may be processed during the method 400.

At block 425, the computing system generates a new block-specific quantization scale (e.g., Iₖ for the block k) based on the shared quantization scale (generated at block 415) and the current or initial block-specific quantization scale (selected at block 420), as discussed above. For example, as discussed above, the computing system may generate an updated or converted block-specific scale Iₖ for each block of the set of blocks in the channel using Equation 2.

At block 430, the computing system determines whether there is at least one additional blockwise scale (from the set of scales accessed at block 405) that has not yet been converted. That is, the computing system may determine whether there is at least one block in the channel that does not yet have a new (e.g., LPBQ) blockwise scale. If so, the method 400 returns to block 420. If not, the method 400 continues to block 435. Although depicted as an iterative process (e.g., selecting and processing each blockwise scale independently) for conceptual clarity, in some aspects, some or all of the scales may be processed partially or entirely in parallel.

At block 435, the computing system outputs the new quantization scales (also referred to as updated and/or converted scales, as discussed above) for the channel. In some aspects, as discussed above, the computing system may optionally quantize or encode the model parameters using the new quantization scales. This quantized version of the model may then be output or otherwise provided for runtime use. In some aspects, the method 400 can be repeated for each logical set of blocks (e.g., each channel) in each parameter tensor for the model.

### Example Method for Machine Learning Using Multi-Scale Quantization

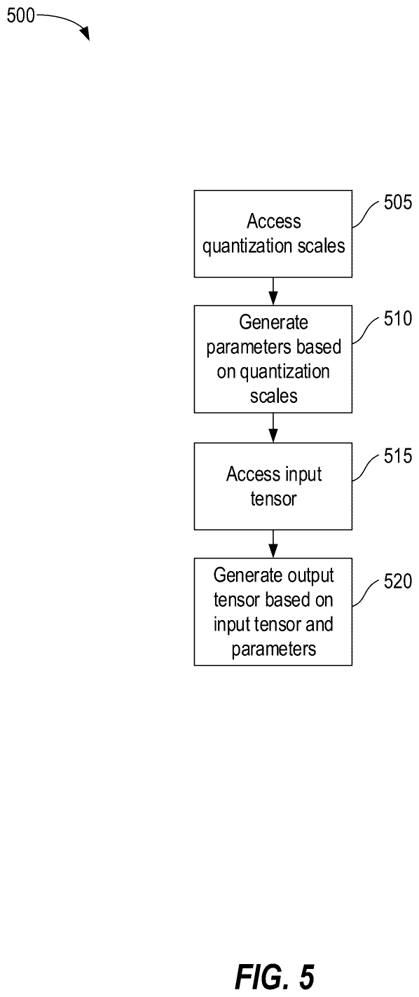

FIG. 5 is a flow diagram depicting an example method 500 for machine learning using multi-scale quantization, according to some aspects of the present disclosure. In some aspects, the method 500 is performed by a conversion system and/or a machine learning system, such as the conversion system 115 and the machine learning system 140 of FIG. 1 and/or the conversion system and/or machine learning system discussed above with reference to FIGS. 2-4. Generally, the method 500 may be performed by any computing system.

At block 505, the computing system accesses a set of updated or converted quantization scales (e.g., the converted scales 135 of FIG. 1 or the converted encodings 330 and/or packed encodings 350 of FIG. 3). For example, as discussed above, the scales may include, for each respective channel of one or more parameter tensors, a respective shared quantization scale (e.g., γ), as well as a respective set of block-specific quantization scales (e.g., I_{1, . . . k}). In some aspects, as discussed above, the computing system may further access a set of quantized machine learning model parameters corresponding to the quantization scales (e.g., the converted parameters 130 of FIG. 1, the converted parameters 230 of FIG. 2, and/or the converted parameters 340 of FIG. 3).

At block 510, the computing system generates a set of (dequantized) parameters for the machine learning model (e.g., the parameters 255 of FIG. 2 and/or the dequantized parameters 360 of FIG. 3) based on the quantization scales. For example, as discussed above, the computing system may combine the shared scale γ for the channel with the block-specific scale Iₖ for the k-th block in the channel to generate an overall scale σₖ for the block. The computing system can then dequantize the block using this overall scale and repeat this process for each block in the channel to generate a set of dequantized parameters for the channel. In some aspects, this process is repeated for each channel in each parameter tensor to generate a dequantized parameter tensor for each component of the model.

At block 515, the computing system accesses an input tensor for the model (e.g., the input that corresponds to or is being processed using the parameters generated at block 510, such as the input activations to the layer that corresponds to the parameters). At block 520, the computing system then generates an output tensor based on the input tensor and the dequantized parameters (e.g., the output of the layer that includes the parameters), such as by using matrix multiplication of the input tensor with the dequantized weight tensor.

In this way, the computing system can use efficient blockwise quantization without relying on customized hardware or expensive floating-point operations.

### Example Method for Generating Multi-Scale Quantization

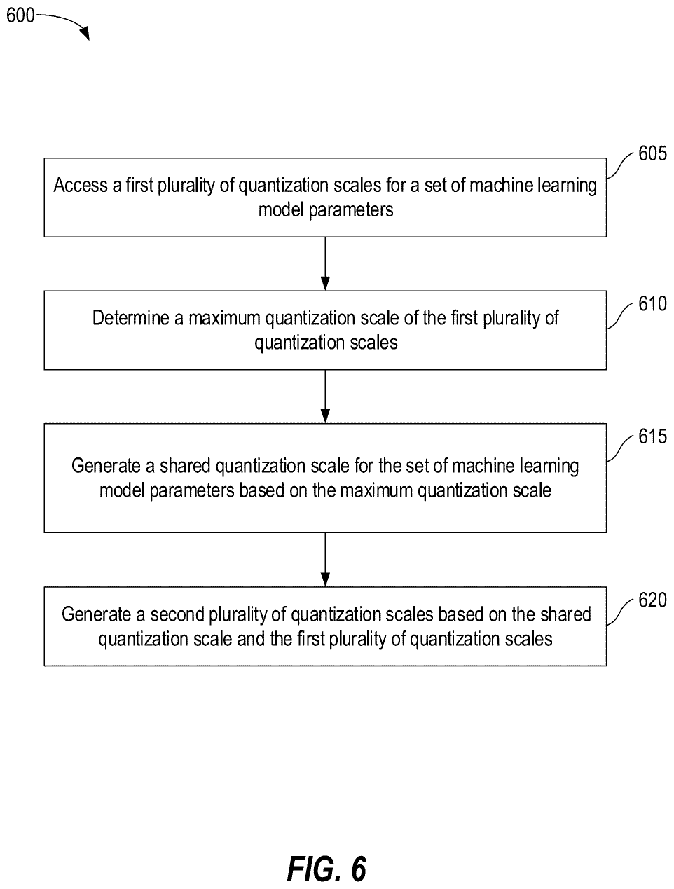

FIG. 6 is a flow diagram depicting an example method 600 for generating multi-scale quantization, according to some aspects of the present disclosure. In some aspects, the method 600 is performed by a computing system, such as the conversion system 115 and/or the machine learning system 140 of FIG. 1, the conversion system and/or machine learning system discussed above with reference to FIG. 2, and/or the computing system discussed above with reference to FIGS. 3-5.

At block 605, a first plurality of quantization scales (e.g., the scales 110 of FIG. 1) for a set of machine learning model parameters (e.g., the model parameters 105 of FIG. 1) is accessed.

At block 610, a maximum quantization scale of the first plurality of quantization scales is determined.

At block 615, a shared quantization scale (e.g., γ) is generated for the set of machine learning model parameters based on the maximum quantization scale.

At block 620, a second plurality of quantization scales (e.g., the converted scales 135) is generated based on the shared quantization scale and the first plurality of quantization scales.

In some aspects, generating the shared quantization scale at block 615 comprises determining a maximum value that can be encoded using a format of the second plurality of quantization scales and dividing the maximum quantization scale by the maximum value.

In some aspects, generating the second plurality of quantization scales at block 620 comprises, for each respective quantization scale of the first plurality of quantization scales, generating a respective interim scale

$$( e . g . , \frac{{s}_{k}}{γ} )$$

by dividing the respective quantization scale by the shared quantization scale.

In some aspects, generating the second plurality of quantization scales at block 620 further comprises, for each respective interim scale, rounding the respective interim scale to a nearest integer value.

In some aspects, generating the second plurality of quantization scales at block 620 further comprises, for each respective rounded interim scale, clamping the respective rounded interim scale to a defined range determined based at least in part on the maximum value.

In some aspects, the set of machine learning model parameters comprises weights for a first channel of a parameter tensor of a first layer of a machine learning model. In this case, the first plurality of quantization scales may comprise blockwise quantization scales (e.g., s) for a set of blocks of the first channel.

In some aspects, each of the first plurality of quantization scales is encoded in a first bitwidth, and each of the second plurality of quantization scales is encoded in a second bitwidth. The second bitwidth may be smaller than the first bitwidth.

In some aspects, the first plurality of quantization scales is encoded in a floating-point format. In this case, the second plurality of quantization scales may be encoded in an integer format.

In some aspects, the method 600 further includes generating a set of quantized machine learning model parameters (e.g., the converted parameters 130 of FIG. 1) based on the set of machine learning model parameters, the shared quantization scale, and the second plurality of quantization scales.

### Example Method for Inferencing Using Multi-Scale Quantization

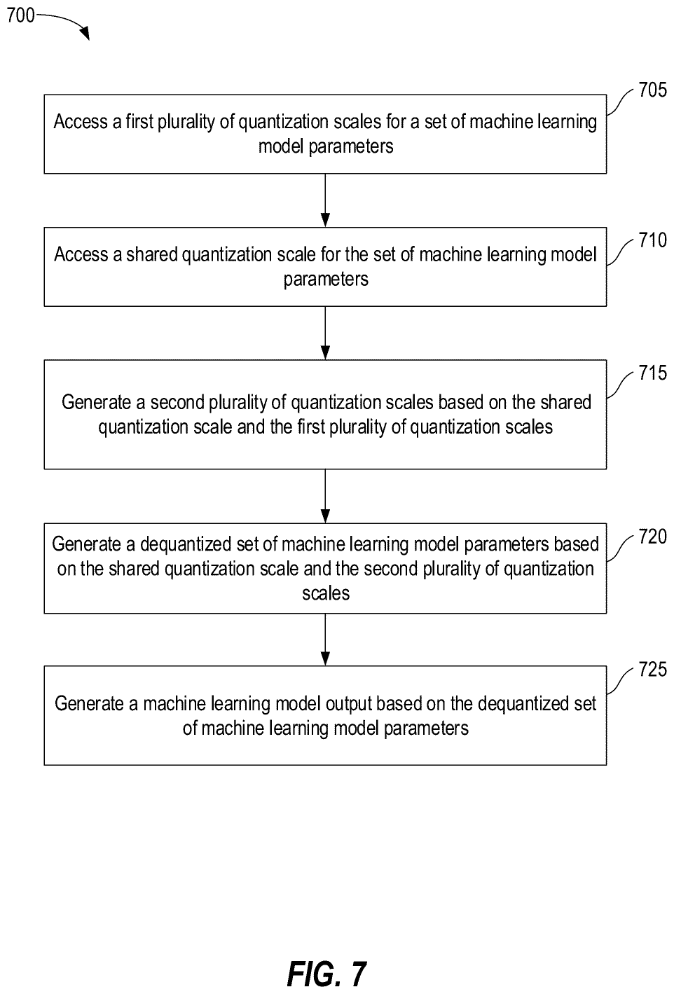

FIG. 7 is a flow diagram depicting an example method 700 for inferencing using multi-scale quantization, according to some aspects of the present disclosure. In some aspects, the method 700 is performed by a computing system, such as the conversion system 115 and/or the machine learning system 140 of FIG. 1, the conversion system and/or machine learning system discussed above with reference to FIG. 2, and/or the computing system discussed above with reference to FIGS. 3-5.

At block 705, a first plurality of quantization scales (e.g., the converted scales 135 of FIG. 1) for a set of machine learning model parameters (e.g., the converted parameters 130 of FIG. 1) is accessed.

At block 710, a shared quantization scale (e.g., γ) for the set of machine learning model parameters is accessed.

At block 715, a second plurality of quantization scales is generated based on the shared quantization scale and the first plurality of quantization scales.

At block 720, a dequantized set of machine learning model parameters (e.g., the dequantized parameters 355 of FIG. 3) is generated based on the shared quantization scale and the second plurality of quantization scales.

At block 725, a machine learning model output (e.g., output 160, 375) is generated based on the dequantized set of machine learning model parameters.

In some aspects, generating the second plurality of quantization scales at block 715 comprises multiplying each respective quantization scale of the first plurality of quantization scales by the shared quantization scale.

In some aspects, the method 700 further includes accessing a quantized set of machine learning model parameters comprising a plurality of blocks of parameters, where generating the dequantized set of machine learning model parameters comprises, for each respective block of parameters from the plurality of blocks of parameters, scaling parameters of the respective block of parameters based on a corresponding overall scale of the plurality of overall scales.

In some aspects, the dequantized set of machine learning model parameters comprise weights for a first channel of a parameter tensor of a first layer of a machine learning model. In this case, the first plurality of quantization scales may comprise blockwise quantization scales (e.g., I) for a set of blocks (e.g., the blocks 210 of FIG. 2) of the first channel.

In some aspects, generating the machine learning model output comprises accessing an input tensor for the first layer of the machine learning model and multiplying the input tensor with the dequantized set of machine learning model parameters to generate an output tensor of the first layer of the machine learning model.

In some aspects, each of the first plurality of quantization scales is encoded in a first bitwidth, and each of the second plurality of quantization scales are encoded in a second bitwidth. The second bitwidth may be greater than the first bitwidth.

In some aspects, the first plurality of quantization scales are packed into data structures having the second bitwidth.

In some aspects, the method 700 further includes accessing a quantized set of machine learning model parameters, where each of the quantized set of machine learning mode parameters is encoded in a first bitwidth, each of the dequantized set of machine learning mode parameters is encoded in a second bitwidth, and the second bitwidth is greater than the first bitwidth.

In some aspects, generating the dequantized set of machine learning model parameters comprises processing a set of quantized machine learning model parameters using at least one of: (i) a matrix engine (ii) a sequence of multiplication operations, or (iii) a hardware accelerator.

### Example Processing System for Machine Learning

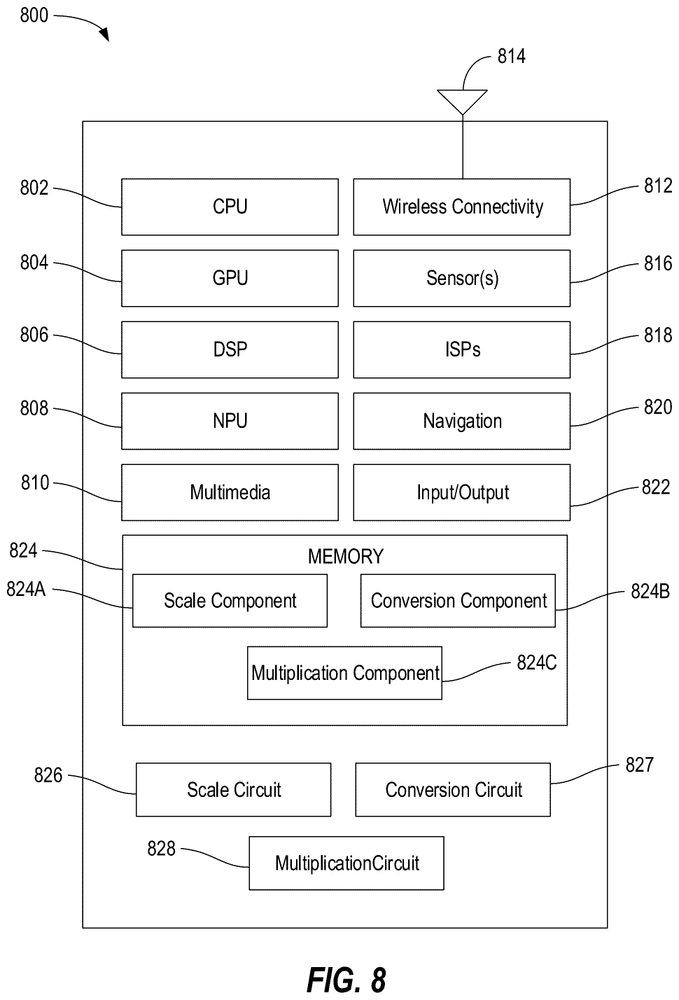

FIG. 8 depicts an example processing system 800 configured to perform various aspects of the present disclosure, including, for example, the techniques and methods described with respect to FIGS. 1-7. In some aspects, the processing system 800 may correspond to a computing system, a conversion system, and/or a machine learning system. For example, the processing system 800 may correspond to the conversion system 115 and/or the machine learning system 140 of FIG. 1, the conversion system and/or the machine learning system discussed above with reference to FIG. 2, and/or the computing systems discussed above with reference to FIGS. 3-7. Although depicted as a single system for conceptual clarity, in some aspects, as discussed above, the components described below with respect to the processing system 800 may be distributed across any number of devices or systems.

The processing system 800 includes a central processing unit (CPU) 802, which in some examples may be a multi-core CPU. Instructions executed at the CPU 802 may be loaded, for example, from a program memory associated with the CPU 802 or may be loaded from a memory partition (e.g., a partition of a memory 824).

The processing system 800 also includes additional processing components tailored to specific functions, such as a graphics processing unit (GPU) 804, a digital signal processor (DSP) 806, a neural processing unit (NPU) 808, a multimedia component 810 (e.g., a multimedia processing unit), and a wireless connectivity component 812.

An NPU, such as the NPU 808, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference). In some implementations, the NPU 808 is a part of one or more of the CPU 802, the GPU 804, and/or the DSP 806.

In some examples, the wireless connectivity component 812 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 812 is further coupled to one or more antennas 814.

The processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

The processing system 800 may also include one or more input and/or output devices 822, such as screens, touch-sensitive surfaces (including touch-sensitive displays), physical buttons, speakers, microphones, and the like.

In some examples, one or more of the processors of the processing system 800 may be based on an ARM or RISC-V instruction set.

The processing system 800 also includes a memory 824, which is representative of one or more static and/or dynamic memories, such as a dynamic random access memory, a flash-based static memory, and the like. In this example, the memory 824 includes computer-executable components, which may be executed by one or more of the aforementioned processors of the processing system 800.

In particular, in this example, the memory 824 includes a scale component 824A, a conversion component 824B, and a multiplication component 824C. Although not depicted in the illustrated example, the memory 824 may also include other components, such as a training component used to train or update machine learning model(s), a quantization component used to quantize the parameters of the model, and the like. Though depicted as discrete components for conceptual clarity in FIG. 8, the illustrated components (and others not depicted) may be collectively or individually implemented in various aspects.

Further, although not depicted in the illustrated example, the memory 824 may also include other data such as model parameters (e.g., parameters of one or more machine learning models), training data for the machine learning model(s), and the like.

The processing system 800 further comprises a scale circuit 826, a conversion circuit 827, and a multiplication circuit 828. The depicted circuits, and others not depicted (such as an inferencing circuit), may be configured to perform various aspects of the techniques described herein.

For example, the scale component 824A and/or the scale circuit 826 may correspond to the scale component 120 of FIG. 1 and/or the scale operation 325 of FIG. 3, and may be used to generate updated or converted scales for machine learning models. For example, the scale component 824A and/or the scale circuit 826 may use Equations 1 and 2 above to convert blockwise quantization scales encoded in a first precision (e.g., sixteen-bit floating point) to a set of converted blockwise quantization scales encoded in a second (lower) precision (e.g., four-bit integer) and a shared quantization scale for a set of blocks (e.g., a channelwise scale).

The conversion component 824B and/or the conversion circuit 827 may correspond to the conversion component 125 of FIG. 1, the conversion component 145 of FIG. 1, the encoding operation 335 of FIG. 3, and/or the parameter dequantization operation 355 of FIG. 3, and may be used to generate converted parameters (e.g., quantized parameters) based on the new or updated quantization scales and/or to dequantize the converted parameters, as discussed above.

The multiplication component 824C and/or the multiplication circuit 828 may correspond to the multiplication component 150 of FIG. 1 and/or the multiplication operation 370 of FIG. 3, and may be used to process input data (e.g., activation tensors) using the dequantized model parameters to generate output tensors, as discussed above.

Though depicted as separate components and circuits for clarity in FIG. 8, the scale circuit 826, the conversion circuit 827, and the multiplication circuit 828 may collectively or individually be implemented in other processing devices of the processing system 800, such as within the CPU 802, the GPU 804, the DSP 806, the NPU 808, and the like.

Generally, the processing system 800 and/or components thereof may be configured to perform the methods described herein.

Notably, in other aspects, aspects of the processing system 800 may be omitted, such as where the processing system 800 is a server computer or the like. For example, the multimedia component 810, the wireless connectivity component 812, the sensor processing units 816, the ISPs 818, and/or the navigation processor 820 may be omitted in other aspects. Further, aspects of the processing system 800 may be distributed between multiple devices.

### Example Clauses

Implementation examples are described in the following numbered clauses:
Clause 1: A method, comprising: accessing a first plurality of quantization scales for a set of machine learning model parameters; determining a maximum quantization scale of the first plurality of quantization scales; generating a shared quantization scale for the set of machine learning model parameters based on the maximum quantization scale; and generating a second plurality of quantization scales based on the shared quantization scale and the first plurality of quantization scales.
Clause 2: A method according to Clause 1, wherein generating the shared quantization scale comprises: determining a maximum value that can be encoded using a format of the second plurality of quantization scales; and dividing the maximum quantization scale by the maximum value.
Clause 3: A method according to Clause 2, wherein generating the second plurality of quantization scales comprises, for each respective quantization scale of the first plurality of quantization scales, generating a respective interim scale by dividing the respective quantization scale by the shared quantization scale.
Clause 4: A method according to Clause 3, wherein generating the second plurality of quantization scales further comprises, for each respective interim scale, rounding the respective interim scale to a nearest integer value.
Clause 5: A method according to Clause 4, wherein generating the second plurality of quantization scales further comprises, for each respective rounded interim scale, clamping the respective rounded interim scale to a defined range determined based at least in part on the maximum value.
Clause 6: A method according to any of Clauses 1-5, wherein: the set of machine learning model parameters comprise weights for a first channel of a parameter tensor of a first layer of a machine learning model, and the first plurality of quantization scales comprise blockwise quantization scales for a set of blocks of the first channel.
Clause 7: A method according to any of Clauses 1-6, wherein: each of the first plurality of quantization scales are encoded in a first bitwidth, and each of the second plurality of quantization scales are encoded in a second bitwidth, wherein the second bitwidth is smaller than the first bitwidth.
Clause 8: A method according to any of Clauses 1-7, wherein: the first plurality of quantization scales are encoded in a floating-point format, and the second plurality of quantization scales are encoded in an integer format.
Clause 9: A method according to any of Clauses 1-8, further comprising generating a set of quantized machine learning model parameters based on the set of machine learning model parameters, the shared quantization scale, and the second plurality of quantization scales.
Clause 10: A method, comprising: accessing a first plurality of quantization scales for a set of machine learning model parameters; accessing a shared quantization scale for the set of machine learning model parameters; generating a second plurality of quantization scales based on the shared quantization scale and the first plurality of quantization scales; generating a dequantized set of machine learning model parameters based on the shared quantization scale and the second plurality of quantization scales; and generating a machine learning model output based on the dequantized set of machine learning model parameters.
Clause 11: A method according to Clause 10, wherein generating the second plurality of quantization scales comprises multiplying each respective quantization scale of the first plurality of quantization scales by the shared quantization scale.
Clause 12: A method according to Clause 11, further comprising accessing a quantized set of machine learning model parameters comprising a plurality of blocks of parameters, wherein generating the dequantized set of machine learning model parameters comprises, for each respective block of parameters from the plurality of blocks of parameters, scaling parameters of the respective block of parameters based on a corresponding overall scale of the plurality of overall scales.
Clause 13: A method according to any of Clauses 10-12, wherein: the dequantized set of machine learning model parameters comprise weights for a first channel of a parameter tensor of a first layer of a machine learning model, and the first plurality of quantization scales comprise blockwise quantization scales for a set of blocks of the first channel.
Clause 14: A method according to Clause 13, wherein generating the machine learning model output comprises: accessing an input tensor for the first layer of the machine learning model; and multiplying the input tensor with the dequantized set of machine learning model parameters to generate an output tensor of the first layer of the machine learning model.
Clause 15: A method according to any of Clauses 10-14, wherein: each of the first plurality of quantization scales are encoded in a first bitwidth, and each of the second plurality of quantization scales are encoded in a second bitwidth, wherein the second bitwidth is greater than the first bitwidth.
Clause 16: A method according to Clause 15, wherein the first plurality of quantization scales are packed into data structures having the second bitwidth.
Clause 17: A method according to any of Clauses 10-16, further comprising accessing a quantized set of machine learning model parameters, wherein: each of the quantized set of machine learning mode parameters is encoded in a first bitwidth, each of the dequantized set of machine learning mode parameters is encoded in a second bitwidth, and the second bitwidth is greater than the first bitwidth.
Clause 18: A method according to any of Clauses 10-17, wherein generating the dequantized set of machine learning model parameters comprises processing a set of quantized machine learning model parameters using at least one of: (i) a matrix engine (ii) a sequence of multiplication operations, or (iii) a hardware accelerator.
Clause 19: A processing system comprising: a memory comprising processor-executable instructions; and one or more processors coupled to the one or more memories and configured to execute the processor-executable instructions and cause the processing system to perform a method in accordance with any of Clauses 1-18.
Clause 20: A processing system comprising means for performing a method in accordance with any of Clauses 1-18.
Clause 21: A non-transitory computer-readable medium comprising computer-executable instructions that, when executed by one or more processors of a processing system, cause the processing system to perform a method in accordance with any of Clauses 1-18.
Clause 22: A computer program product embodied on a computer-readable storage medium comprising code for performing a method in accordance with any of Clauses 1-18.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning comprising:
one or more memories comprising processor-executable instructions; and
one or more processors coupled to the one or more memories and configured to execute the processor-executable instructions and cause the processing system to:
access a first plurality of quantization scales for a set of machine learning model parameters;
access a shared quantization scale for the set of machine learning model parameters;
generate a second plurality of quantization scales based on the shared quantization scale and the first plurality of quantization scales;
generate a dequantized set of machine learning model parameters based on the shared quantization scale and the second plurality of quantization scales; and
generate a machine learning model output based on the dequantized set of machine learning model parameters.

2. The processing system of claim 1, wherein, to generate the second plurality of quantization scales, the one or more processors are configured to execute the processor-executable instructions and cause the processing system to multiply each respective quantization scale of the first plurality of quantization scales by the shared quantization scale.

3. The processing system of claim 2, wherein the one or more processors are configured to execute the processor-executable instructions and further cause the processing system to access a quantized set of machine learning model parameters comprising a plurality of blocks of parameters, wherein, to generate the dequantized set of machine learning model parameters, the one or more processors are configured to execute the processor-executable instructions and cause the processing system to, for each respective block of parameters from the plurality of blocks of parameters, scale parameters of the respective block of parameters based on a corresponding overall scale of the plurality of overall scales.

4. The processing system of claim 1, wherein:
the dequantized set of machine learning model parameters comprises weights for a first channel of a parameter tensor of a first layer of a machine learning model, and
the first plurality of quantization scales comprises blockwise quantization scales for a set of blocks of the first channel.

5. The processing system of claim 4, wherein, to generate the machine learning model output, the one or more processors are configured to execute the processor-executable instructions and cause the processing system to:
access an input tensor for the first layer of the machine learning model; and
multiply the input tensor with the dequantized set of machine learning model parameters to generate an output tensor of the first layer of the machine learning model.

6. The processing system of claim 1, wherein:
each of the first plurality of quantization scales is encoded in a first bitwidth,
each of the second plurality of quantization scales is encoded in a second bitwidth, and
the second bitwidth is greater than the first bitwidth.

7. The processing system of claim 6, wherein the first plurality of quantization scales are packed into data structures having the second bitwidth.

8. The processing system of claim 1, wherein the one or more processors are configured to execute the processor-executable instructions and cause the processing system to access a quantized set of machine learning model parameters, wherein:
each of the quantized set of machine learning mode parameters is encoded in a first bitwidth,
each of the dequantized set of machine learning mode parameters is encoded in a second bitwidth, and
the second bitwidth is greater than the first bitwidth.

9. The processing system of claim 1, wherein, to generate the dequantized set of machine learning model parameters, the one or more processors are configured to execute the processor-executable instructions and cause the processing system to process a set of quantized machine learning model parameters using at least one of: (i) a matrix engine (ii) a sequence of multiplication operations, or (iii) a hardware accelerator.

10. A processor-implemented method for machine learning, comprising:
accessing a first plurality of quantization scales for a set of machine learning model parameters;
accessing a shared quantization scale for the set of machine learning model parameters;
generating a second plurality of quantization scales based on the shared quantization scale and the first plurality of quantization scales;
generating a dequantized set of machine learning model parameters based on the shared quantization scale and the second plurality of quantization scales; and
generating a machine learning model output based on the dequantized set of machine learning model parameters.

11. The processor-implemented method of claim 10, wherein generating the second plurality of quantization scales comprises multiplying each respective quantization scale of the first plurality of quantization scales by the shared quantization scale to generate a plurality of overall scales.

12. The processor-implemented method of claim 11, further comprising accessing a quantized set of machine learning model parameters comprising a plurality of blocks of parameters, wherein generating the dequantized set of machine learning model parameters comprises, for each respective block of parameters from the plurality of blocks of parameters, scaling parameters of the respective block of parameters based on a corresponding overall scale of the plurality of overall scales.

13. The processor-implemented method of claim 10, wherein:
the dequantized set of machine learning model parameters comprises weights for a first channel of a parameter tensor of a first layer of a machine learning model, and
the first plurality of quantization scales comprises blockwise quantization scales for a set of blocks of the first channel.

14. The processor-implemented method of claim 13, wherein generating the machine learning model output comprises:
accessing an input tensor for the first layer of the machine learning model; and
multiplying the input tensor with the dequantized set of machine learning model parameters to generate an output tensor of the first layer of the machine learning model.

15. The processor-implemented method of claim 10, wherein:
each of the first plurality of quantization scales is encoded in a first bitwidth,
each of the second plurality of quantization scales is encoded in a second bitwidth, and
the second bitwidth is greater than the first bitwidth.

16. The processor-implemented method of claim 15, wherein the first plurality of quantization scales are packed into data structures having the second bitwidth.

17. The processor-implemented method of claim 10, further comprising accessing a quantized set of machine learning model parameters, wherein:
each of the quantized set of machine learning mode parameters is encoded in a first bitwidth,
each of the dequantized set of machine learning mode parameters is encoded in a second bitwidth, and
the second bitwidth is greater than the first bitwidth.

18. The processor-implemented method of claim 10, wherein generating the dequantized set of machine learning model parameters comprises processing a set of quantized machine learning model parameters using at least one of: (i) a matrix engine (ii) a sequence of multiplication operations, or (iii) a hardware accelerator.

19. A processing system for machine learning comprising:
one or more memories comprising processor-executable instructions; and
one or more processors coupled to the one or more memories and configured to execute the processor-executable instructions and cause the processing system to:
access a first plurality of quantization scales for a set of machine learning model parameters;
determine a maximum quantization scale of the first plurality of quantization scales;
generate a shared quantization scale for the set of machine learning model parameters based on the maximum quantization scale; and
generate a second plurality of quantization scales based on the shared quantization scale and the first plurality of quantization scales.

20. The processing system of claim 19, wherein, to generate the shared quantization scale, the one or more processors are configured to execute the processor-executable instructions and cause the processing system to:
determine a maximum value that can be encoded using a format of the second plurality of quantization scales; and
divide the maximum quantization scale by the maximum value.

21. The processing system of claim 20, wherein, to generate the second plurality of quantization scales, the one or more processors are configured to execute the processor-executable instructions and further cause the processing system to, for each respective quantization scale of the first plurality of quantization scales, generate a respective interim scale by dividing the respective quantization scale by the shared quantization scale.

22. The processing system of claim 21, wherein, to generate the second plurality of quantization scales, the one or more processors are configured to execute the processor-executable instructions and further cause the processing system to, for each respective interim scale, round the respective interim scale to a nearest integer value.

23. The processing system of claim 22, wherein, to generate the second plurality of quantization scales, the one or more processors are configured to execute the processor-executable instructions and further cause the processing system to, for each respective rounded interim scale, clamp the respective rounded interim scale to a defined range determined based at least in part on the maximum value.

24. The processing system of claim 19, wherein:
the set of machine learning model parameters comprises weights for a first channel of a parameter tensor of a first layer of a machine learning model, and
the first plurality of quantization scales comprises blockwise quantization scales for a set of blocks of the first channel.

25. The processing system of claim 19, wherein:
each of the first plurality of quantization scales is encoded in a first bitwidth,
each of the second plurality of quantization scales is encoded in a second bitwidth, and
the second bitwidth is smaller than the first bitwidth.

26. The processing system of claim 19, wherein:
the first plurality of quantization scales is encoded in a floating-point format, and
the second plurality of quantization scales is encoded in an integer format.

27. The processing system of claim 19, wherein the one or more processors are configured to execute the processor-executable instructions and further cause the processing system to generate a set of quantized machine learning model parameters based on the set of machine learning model parameters, the shared quantization scale, and the second plurality of quantization scales.

28. A processor-implemented method for machine learning, comprising:
accessing a first plurality of quantization scales for a set of machine learning model parameters;
determining a maximum quantization scale of the first plurality of quantization scales;
generating a shared quantization scale for the set of machine learning model parameters based on the maximum quantization scale; and
generating a second plurality of quantization scales based on the shared quantization scale and the first plurality of quantization scales.

29. The processor-implemented method of claim 28, wherein generating the shared quantization scale comprises:
determining a maximum value that can be encoded using a format of the second plurality of quantization scales; and
dividing the maximum quantization scale by the maximum value.

30. The processor-implemented method of claim 29, wherein generating the second plurality of quantization scales comprises, for each respective quantization scale of the first plurality of quantization scales, generating a respective interim scale by dividing the respective quantization scale by the shared quantization scale.

31. The processor-implemented method of claim 30, wherein generating the second plurality of quantization scales further comprises, for each respective interim scale, rounding the respective interim scale to a nearest integer value.

32. The processor-implemented method of claim 31, wherein generating the second plurality of quantization scales further comprises, for each respective rounded interim scale, clamping the respective rounded interim scale to a defined range determined based at least in part on the maximum value.

33. The processor-implemented method of claim 28, wherein:
the set of machine learning model parameters comprises weights for a first channel of a parameter tensor of a first layer of a machine learning model, and
the first plurality of quantization scales comprises blockwise quantization scales for a set of blocks of the first channel.

34. The processor-implemented method of claim 28, wherein:
each of the first plurality of quantization scales is encoded in a first bitwidth,
each of the second plurality of quantization scales is encoded in a second bitwidth, and
the second bitwidth is smaller than the first bitwidth.

35. The processor-implemented method of claim 28, wherein:
the first plurality of quantization scales is encoded in a floating-point format, and
the second plurality of quantization scales is encoded in an integer format.

36. The processor-implemented method of claim 28, further comprising generating a set of quantized machine learning model parameters based on the set of machine learning model parameters, the shared quantization scale, and the second plurality of quantization scales.
